(19) United States
(12) Patent Application Publication
(10) Pub. No.: US 2025/0389849 A1
(43) Pub. Date: Dec. 25, 2025

(54) TIME-OF-FLIGHT CAMERA SYSTEM AND DISTORTION COMPENSATION METHOD FOR A TIME-OF-FLIGHT CAMERA SYSTEM

(71) Applicant: ams-OSRAM AG, Premstaetten (AT)

(72) Inventors: Nicolino STASIO, Zürich (CH); Andreas BRUECKNER, Gröbenzell (DE); Kai ENGELHARDT, Buckenhof (DE); Preethi PADMANABHAN, Zürich (CH); Alexandre POLLINI, St-Blaise (CH)

(21) Appl. No.: 18/881,196

(22) PCT Filed: Jun. 21, 2023
(86) PCT No.: PCT/EP2023/066815

§ 371 Date: Jan. 3, 2025

(30) Foreign Application Priority Data
Jul. 4, 2022 (DE) 10 2022 116 581.7

(51) Int. Cl. G01S 17/894; G01S 7/481

(52) U.S. Cl. CPC G01S 17/894; G01S 7/4815; G01S 7/4816

(57) ABSTRACT

A time-of-flight, TOF, camera comprises a dot projector formed from an array of light emitters and a projection lens, the dot projector being configured to project a dot pattern onto a target. The TOF camera further comprises an optical sensor formed from an array of sensor pixels and a camera lens, the optical sensor being configured to capture the dot pattern projected onto the target. A distortion of the array of light emitters, a transfer function of the projection lens and/or a transfer function of the camera lens is set such that the captured dot pattern is free of optical distortion.

This disclosure relates to a time-of-flight, TOF, camera system and to a distortion compensation method for a TOF camera system.

### BACKGROUND OF THE INVENTION

Time-of-flight cameras are 3D-camera systems configured to measure distances to a target, e.g. an object or a scene, using the time-of-flight, TOF, method. To this end, the target is illuminated by means of a light pulse from a light emitter of the camera, and a sensor element of the camera captures the reflected light from the target. Consequently, a processing unit determines the time it takes for the light to reach the target and back again for each pixel. Therein, the determined time is directly proportional to the distance to the target. Thus, for each pixel, the camera can provide the distance of the target imaged on it. Typically, the illumination is realized by projecting a dot pattern onto the target, and capturing the reflected dot pattern by means of an image sensor.

Conventional TOF cameras comprise a dot projector for projecting the dot pattern onto the target and an optical sensor for capturing the reflected dot pattern. However, due to the non-ideal lenses employed in existing TOF cameras, these systems typically experience a substantial amount of optical distortion in both the dot pattern projected onto the target and the reflected dot pattern received by the optical sensor. Existing approaches to overcome the limitations of distortion include an increased number of pixels of the optical sensor as well as digital pre-distortion. However, these approaches have the disadvantage of excessive energy consumption and high computational efforts for analyzing the captured signals.

Thus, an object to be achieved is to provide a time-of-flight camera that overcomes the limitations of existing solutions. A further object is to provide a distortion compensation method for a TOF camera.

These objects are achieved with the subject-matter of the independent claims. Further developments and embodiments are described in dependent claims.

### SUMMARY OF THE INVENTION

This disclosure overcomes the abovementioned limitations of modern day devices by distorting the arrangement of the light emitter array and/or the transfer functions of the optical lenses employed in the system for minimizing, i.e. compensating, the optical distortion without requiring any additional components or digital image processing methods. This allows to optimize the number of emitters needed according to the number of pixels, in turn reducing costs, improving optical power throughput, maximizing efficiency and making the TOF optical system more robust against tolerances.

In an embodiment, a time-of-flight camera system comprises a dot projector, which is formed from an array of light emitters as well as a projection lens. The dot projector is configured to project a dot pattern onto a target a distance is to be determined to. The TOF camera further comprises an optical sensor, which is formed from an array of sensor pixels and a camera lens. The optical sensor is configured to capture the dot pattern projected onto and reflected from the target back to the TOF camera. Therein, a distortion of the array of light emitters, a transfer function of the projection lens and/or a transfer function of the camera lens is set such that the captured dot pattern is free of optical distortion.

The dot projector can be effectively regarded as a structured light source comprising means to project a grid of dots, i.e. a dot pattern, onto a target, which can be a scene or an object, to which the distance and optionally of which the topographic characteristics is to be determined. Said means can comprise an array of light emitters, e.g. configured to emit light in the infrared domain in order to make the illumination with the grid unobtrusive to the human eye. A lens arrangement acting as the projection lens is then configured to direct light towards the target and create the intended dot pattern on a surface of the target.

The optical sensor comprises an array of sensor pixels, each pixel comprising a photodiode, for example, which is configured to generate an electronic photo signal based on light captured by the respective photodiode within an integration, or exposure, time. For example, the optical sensor comprises an image sensor formed from an array, e.g. a grid, of pixels. Like the dot projector, the optical sensor comprises input optics such as a camera lens for directing the light that is emitted by the dot projector and reflected from the target onto the sensor pixels. The optical sensor can comprise further optical elements such as an optical filter for rejecting light of unwanted incidence angles and/or unwanted optical wavelengths.

The dot projector and the optical sensor can be arranged on a common substrate body, e.g. a chip or a wafer substrate. The TOF camera can be a CMOS device including an integrated circuit portion for operating the TOF camera. For example, an integrated circuit synchronizes the emission of light of the dot projector and an integration time of the sensor pixels. The integrated circuit can be further configured to determine, for each pixel, a time difference between the emission of light of the dot projector and the generation of a photo signal of a corresponding pixel.

The improved concept optically compensates for any distortion caused by non-ideal optical elements such as the projection and camera lenses. For example, the array of light emitters can be distorted in order to reverse an optical distortion introduced by the projection and camera lenses. Alternatively, an optical distortion of one of the lenses can be engineered via its transfer function in order to reverse an optical distortion generated by the respective other lens. Yet alternatively, the array of sensor pixels can be distorted in order to reverse an optical distortion introduced by the projection and camera lenses. Furthermore, a combination of the abovementioned features can be employed for achieving an enhanced suppression of optical distortion, e.g. by means of distorting the array of light emitters and engineering the transfer functions of the projection lens, the camera lens, or both lenses. The camera system can be multispectral or monochromatic.

In an embodiment, each sensor pixel is adapted to detect a dot of the dot pattern that is generated by a light emitter located at a coordinate in the array of light emitters corresponding to a coordinate in the array of sensor pixels of the respective sensor pixel. This way, it can be ensured that light of each dot generated by the dot projector via the target reaches a corresponding sensor pixel, wherein the correspondence means that a grid position of the light emitter and that of the corresponding sensor pixel are equal in terms of row and column numbers, for instance. This enables full control of the respective position of the depth points for 3D systems, ideally, by getting the exact same number of points for each pixel of the sensor. This minimizes the number of emitters needed in the emitter array, in turn reducing cost and improving optical power throughput, which brings an increased range of detection, important for example, in Lidar systems.

In an embodiment, a number of light emitters corresponds to a number of sensor pixels. As mentioned before, ideally each pixel is configured to detect light from a reflected dot of the dot pattern generated by a corresponding one of the light emitters. Conventional approaches compensate for distortion by employing an image sensor with a larger number of sensor pixels compared to the number of light emitters. This way, all dots can be captured, however, a substantial amount of sensor pixels will not detect any dot such that their operation is not essential and just leads to a large energy consumption. If the input and output optics are engineered to compensate for optical distortion, as realized by the improved concept, the optical sensor and the dot projector and comprise and equal amount of pixels such that size and cost of the TOF camera can be kept minimum while an optimal power consumption budget is maintained. For example, the array of light emitters and the array of sensor pixels are equal in terms of a number of rows and columns, with an emitter or sensor being arranged at each grid point of the array.

In an embodiment, the transfer function of the camera lens is set such that light of each dot of the dot pattern is directed to a center of a capturing surface of a corresponding sensor pixel. An advantage of this feature is linked to tolerances. Tolerances can effectively shift dots on the sensor plane. A requirement of a reliable TOF measurement is typically having one dot imaged per pixel. Moreover, to be robust against tolerances, the best option is to image each dot of the projected dot pattern at the center of each pixel of the optical sensor. If a dot is imaged by a pixel close to the edge of a sensitive photon capturing surface, however, an imaging of the dot can fail as soon as tolerances are introduced.

In an embodiment, the transfer function of the camera lens is set such that a distortion of the dot pattern caused by the distortion of the array of light emitters and/or the transfer function of the projection lens is reversed. The camera lens on the input side of the TOF camera can be engineered in terms of its transfer function to introduce into the system a distortion of the same magnitude but opposite sign to any optical distortion generated by the dot projector, e.g. a distortion of the emitter array and an optical distortion of the projection lens, compared to an ideal system, i.e. an emitter array without distortion and an ideal projection lens without any optical distortion. Thus, it is ensured, that each dot of the projected dot pattern can be captured by a corresponding pixel of the optical sensor for realizing a reliable TOF measurement.

In an embodiment, the distortion of the array of light emitters is set such that the dot pattern is free of any distortion. For example, the optical sensor's input optics do not introduce any distortion. This is realized by the camera lens either behaving similar to an ideal lens, or by the camera lens being formed from a lens arrangement wherein the individual lens elements compensate each other's distortion or that of other optical elements such as optical filters, for instance. In such cases, a distorted arrangement of light emitters can be employed for compensating the optical distortion introduced by the projection lens. As a result, also the dot pattern projected onto the target is free of any distortion. For example, the array of light emitters features a barrel type distortion, a pincushion type distortion, a combination of a barrel and a pincushion type distortion, or a complex type distortion in order to compensate the optical distortion introduced by the projection lens.

In an embodiment, the transfer function of the projection lens is set such that the dot pattern is free of any distortion. The abovementioned distortion-free dot pattern on the target can be likewise achieved or further enhanced by a specifically engineered transfer function of the projection lens. For example, the transfer function of the projection lens is set to resemble an ideal lens such that a distortion-free array of light emitters translates into a distortion-free projection of the dot pattern. Alternatively, a distortion of the array of light emitters in combination with a lens transfer function tailored to this can lead to an enhanced minimization of any distortion in the projected pattern.

In an embodiment, the distortion of the array of light emitters is set such that a predetermined distortion of the dot pattern on the target is achieved. In contrast to the above-mentioned embodiments, in which the dot pattern is generated free of any distortion in cases the input optics of the optical sensor does not introduce any optical distortions, a distorted dot pattern can be generated, wherein a distortion of the dot pattern matches an optical distortion of the camera lens in magnitude but being of opposite sign. For example, the camera lens is a non-ideal lens with a transfer function that introduces optical distortion. Thus, the dot pattern can be generated in a way that the transfer function of the camera lens precisely reverses a distortion of the dot pattern on the target such that every dot is captured by a corresponding one of the sensor pixels, which are arranged in a non-distorted rectangular array, for instance. To realize the pre-distortion of the dot pattern, a known transfer function of the projection lens in combination with a specific distortion of the array of light emitters can be employed. For example, the array of light emitters features a barrel type distortion, a pincushion type distortion, a combination of a barrel and a pincushion type distortion, or a complex type distortion in order to achieve a predetermined distortion of the dot pattern on the target.

In an embodiment, the transfer function of the projection lens is set such that a predetermined distortion of the dot pattern on the target is achieved. The abovementioned pre-distortion of the dot pattern on the target can be likewise achieved or further enhanced by a specifically engineered transfer function of the projection lens. For example, the transfer function of the projection lens is set to resemble a non-ideal lens such that a distortion-free array of light emitters translates into a distorted projection of the dot pattern. Alternatively, a distortion of the array of light emitters in combination with a lens transfer function tailored to this can lead to an enhanced achievement of the intended distortion in the projected pattern.

In an embodiment, the transfer function of the camera lens is set such that the predetermined distortion of the dot pattern on the target is reversed. In order to ensure that each dot is captured by the correct corresponding pixel in the array of pixels, the transfer function of the camera lens introduces an optical distortion that is of the same magnitude but of different signs compared to an optical distortion of the dot pattern on the target that is introduced by the transfer function of a non-ideal projection lens and/or a distorted array of light emitters.

In an embodiment, the light emitters are coherent light emitters, in particular vertical-cavity surface-emitting lasers, VCSELs. VCSELs are extremely energy-efficient light emitters in the infrared domain, e.g. the NIR or SWIR domain. An array of VCSELs can hence be employed for generating the intended dot pattern on a surface of the target. Alternatively, the light emitters can be any other type of coherent light emitters such as edge emitters or other types of lasers.

In an embodiment, each of the sensor pixels comprises a photodiode, in particular a micro photodiode. For example, the optical sensor employs an image sensor formed from silicon-based photodiodes that experience a sensitivity in the infrared domain, particularly in the NIR domain. On their light sensitive surface, the photodiodes can be coated with a filter layer that predominantly or exclusively transmits light at optical wavelengths corresponding to the emitted light from the light emitters. Micro photodiodes can further support a reduction of the overall size of the image sensor.

In an embodiment, the projection lens is formed from one of: injection-molded optics, wafer-level optics, a metalens, a micro-lens array. In an embodiment, the camera lens is formed from one of: injection-molded optics, wafer-level optics, a metalens, a micro-lens array. Both the projection and camera lenses can be formed from the above-mentioned elements depending on the specific applications and on spatial constraints, for instance. In particular, metalenses can be engineered in a straight-forward manner for achieving a specific transfer function.

In an embodiment, the dot projector comprises a single light emitter and further comprises a diffractive optical element, DOE, configured to generate a dot array from light received from the single light emitter. The array of light emitters can consist of a single light emitter, from which a dot pattern is generated by means of a diffractive optical element. This is particularly of relevance for embodiments, in which a low power consumption is absolutely essential, e.g. for applications in battery powered devices.

The above-mentioned object is further achieved by an electronic device comprising a TOF camera according to one of the embodiments described above. The electronic device can be a mobile computing device, such as a smartphone, laptop or tablet computer, or a wearable device such as a smart watch or smart glasses. Moreover, the electronic device can be a sensor unit of a vehicle, in which the TOF camera acts as a LIDAR system for determining distances and monitoring velocities of objects and the scene around the vehicle.

Furthermore, a distortion compensation method for a time-of-flight camera is provided. The method comprises providing a dot projector formed from an array of light emitters and a projection lens, and providing an optical sensor formed from an array of sensor pixels and a camera lens. The method further comprises projecting, by means of the dot projector, a dot pattern onto a target, and capturing, by means of the optical sensor, the dot pattern projected onto the target. Therein, a distortion of the array of light emitters, a transfer function of the projection lens and/or a transfer function of the camera lens is set such that the captured dot pattern is free of optical distortion.

Further embodiments of the method become apparent to the skilled reader from the aforementioned embodiments of the TOF camera, and vice-versa.

### BRIEF DESCRIPTION OF THE DRAWINGS

The following description of figures may further illustrate and explain aspects of the TOF camera and the distortion compensation method. Components and parts of the TOF camera that are functionally identical or have an identical effect are denoted by identical reference symbols. Identical or effectively identical components and parts might be described only with respect to the figures where they occur first. Their description is not necessarily repeated in successive figures.

### DETAILED DESCRIPTION

In the figures:

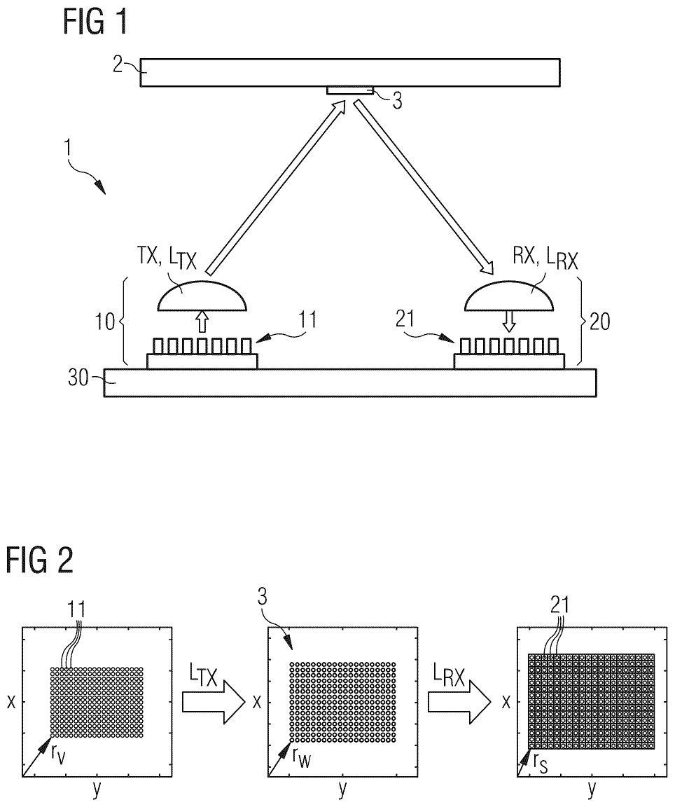

FIG. 1 shows a schematic of an exemplary embodiment of a TOF camera according to the improved concept;

FIG. 2 illustrates the working principle of generating and capturing a dot pattern;

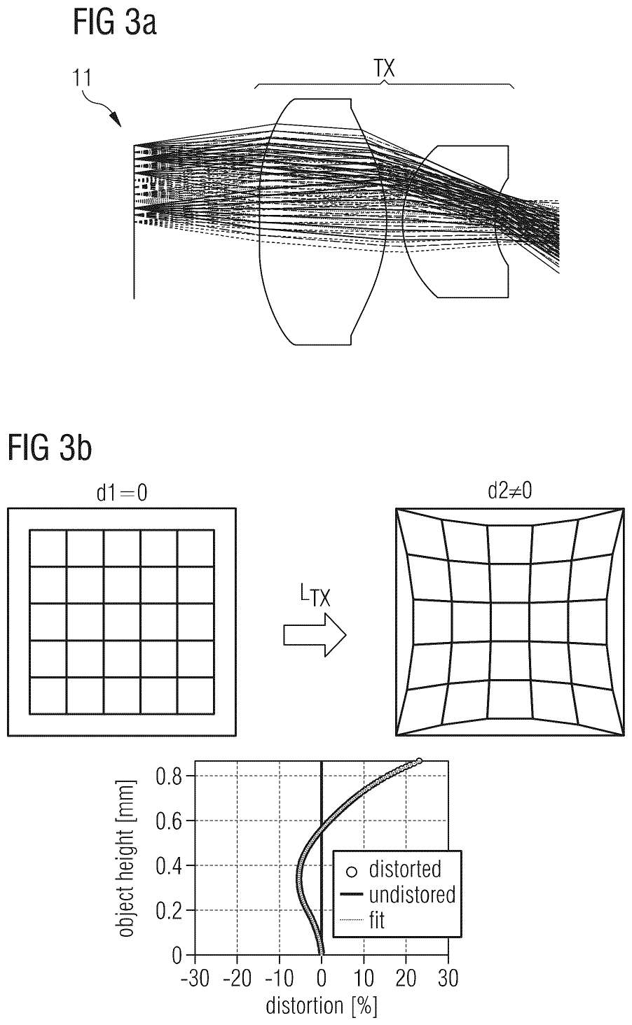

FIG. 3a shows an exemplary embodiment of a projection lens employed in a TOF camera according to the improved concept;

FIG. 3b illustrates a distortion of the dot pattern introduced by a projection lens;

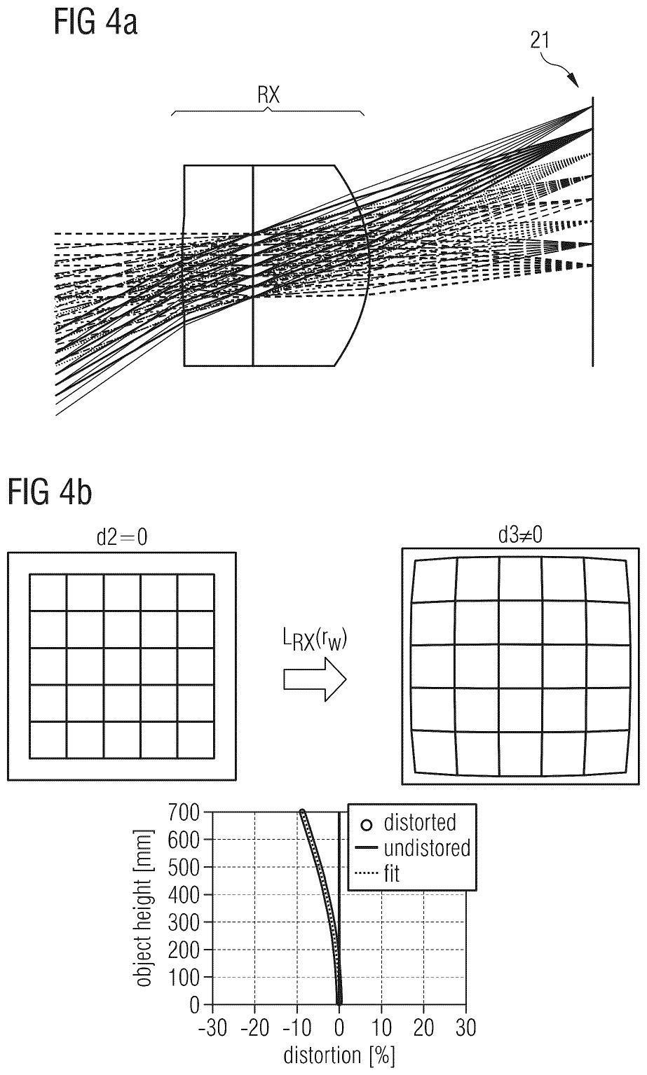

FIG. 4a shows an exemplary embodiment of a camera lens employed in a TOF camera according to the improved concept;

FIG. 4b illustrates a distortion of the captured dot pattern introduced by a camera lens;

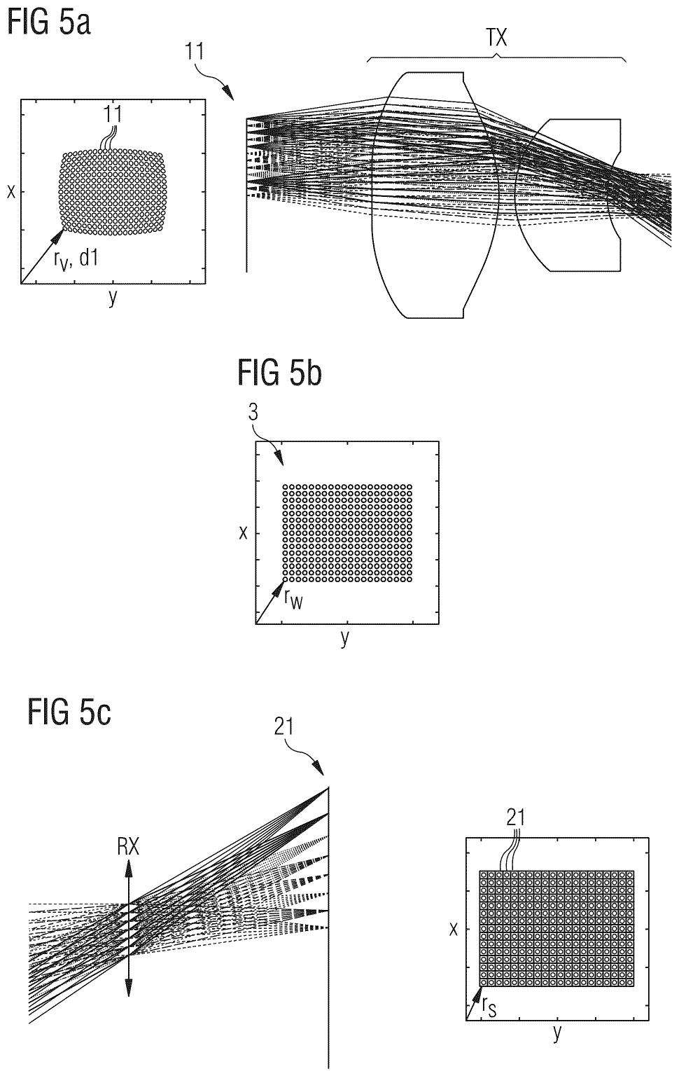

FIGS. 5 to 8 show various embodiments of arrays of light emitters, projection and camera lenses, and their working principle; and

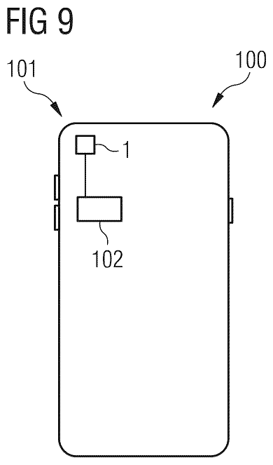

FIG. 9 shows an exemplary embodiment of an electronic device comprising a TOF camera according to the improved concept.

FIG. 1 shows a schematic of an exemplary embodiment of a TOF camera 1 according to the improved concept. The TOF camera 1 comprises a dot projector 10 and an optical sensor 20, which are arranged on a common substrate 30, e.g. a silicon chip substrate. The dot projector 10 comprises an array of light emitters 11, which is realized by means of a grid of vertical-cavity surface-emitting lasers, VCSELs, arranged on an emitter substrate, for instance. The light emitters 11 can alternatively be edge emitters or any other type of emitter that is operable to emit coherent light. The light emitted by the light emitters 11 is infrared light, in particular NIR or SWIR light, for instance. The dot projector 10 further comprises a projection lens TX that is configured to receive light that is emitted by the light emitters 11 and project said light onto a surface of a target 2 as a dot pattern 3, i.e. as a grid of dots. The projection lens TX can be a single lens element or an arrangement of a plurality of lens elements. The projection lens TX can be formed from injection-molded optics, wafer-level optics, a metalens or a micro-lens array. In the latter case a number of micro-lenses can correspond to a number of light emitters 11, such that each of the micro-lenses is associated to a light emitter. Alternatively, a number of micro-lenses can be different from the number of light emitters, as it is realized by dot projectors, for instance.

The projection lens TX can comprise a coating realizing an optical filter for rejecting unwanted wavelengths of light, e.g. wavelength not emitted by the light emitters 11. The dot projector 10 can further comprise optical elements such as an optical filter and/or a diffractive optical element DOE such as a Bragg grating. Particularly in embodiments, in which the dot projector 10 comprises a single light emitter 11, a diffractive optical element DOE can be employed to split the light from the emitter 11 into a dot pattern.

The optical sensor 20 comprises an array of sensor pixels 21, which is realized by means of a grid of photodiodes arranged on a sensor substrate, for instance. The sensor pixels 21 can be silicon-based photodiodes, particularly micro photodiodes, or any other type of optical detector that is operable to detect light at optical wavelengths emitted by the dot projector 10. The optical sensor 20 further comprises a camera lens RX that is configured to receive light that is emitted by the light emitters 11 and reflected by the target 2, and to direct the received light to the array of sensor pixels 21. In other words, the camera lens RX is configured to receive the projected dot pattern 3 and provide it to the sensor pixels 21. The camera lens RX can be a single lens element or an arrangement of a plurality of lens elements. The camera lens RX can be formed from injection-molded optics, wafer-level optics, a metalens or a micro-lens array. In the latter case a number of micro-lenses can correspond to a number of sensor pixels 21, such that each of the micro-lenses is associated to a sensor pixel.

The camera lens RX can comprise a coating realizing an optical filter for rejecting unwanted wavelengths of light, e.g. wavelength not emitted by the light emitters 11. The optical sensor 20 can further comprise optical elements such as an optical filter for preventing unwanted light from being detected by the sensor pixels 21.

The TOF camera 1 can further comprise active and passive circuitry for operating the dot projector 10 and the optical sensor 20. In particular, a processing unit can be configured to control the emission of light and control an exposure period of the sensor pixels 21 of the optical sensor 20 for determining the time difference between emission and reception of a light pulse. The concept of TOF measurements is a well-known concept and is not further detailed throughout this disclosure. Instead, the following figures illustrate relevant aspects of the improved concept with respect to distortion compensation.

FIG. 2 illustrates the working principle of generating and capturing a dot pattern using an array of light emitters 11, an array of sensor pixels 21, and projection and camera lenses TX, RX as illustrated in the schematic of FIG. 1. The array of light emitters 11 can be a rectangular array as illustrated, in this case free from any distortion d1 of the arrangement. By defining a coordinate system, a position of each of the light emitters can be described by a position vector r_{V}. The light emitted by the emitters 11 is projected as a dot pattern 3 onto a target by means of the projection lens TX, which is characterized by a transfer function L_{TX}. Hence, a position vector r_{W} of each dot in the dot pattern 3 is given by r_{W}=L_{TX}(r_{V}). In contrast, for a known dot pattern 3, the array of the light emitters 11 is given by

$${r}_{V} = {L}_{TX}^{- 1} ( {r}_{W} ) .$$

Similarly, the dot pattern 3 is received by the camera lens RX, which is characterized by a transfer function L_{RX}. Thus, a position vector r_{S} of each dot in the dot pattern 3 projected onto the corresponding sensor pixel 21 is given by r_{S}=L_{RX}(r_{W})=L_{RX}(L_{TX}(r_{V})).

For illustrating this working principle, the projection and camera lenses TX, RX are shown to be ideal lenses that do not introduce any optical distortion. In other words, the rectangular distortion-free arrangement of the array of light emitters 11 is translated into a distortion-free dot pattern 3 on the target 2 as well as into a distortion-free dot pattern received by the sensor pixels 21. In yet other words, each dot of the dot pattern 3 is directed into the center of a photosensitive surface of each of the sensor pixels 21, as shown in the figure. Therein, each dot is generated by a light emitter having a specific coordinate, i.e. row and column position, in the array of light emitters 11, and captured by a corresponding one of the sensor pixels 21 having the same coordinate in its array, i.e. the same column and row number. However, real lenses do introduce optical distortion such that a compensation mechanism is required in order to maintain the full resolution of a TOF measurement.

FIG. 3a illustrates an exemplary embodiment of a projection lens TX, which in this case is a serial arrangement of two lens elements. Also in this case, the projection lens TX can be described by means of a single transfer function L_{TX} as introduced above.

FIG. 3b illustrates the distortion in the dot pattern 3 generated by the projection lens TX of FIG. 3a. If the array of light emitters 11 is a regular grid, i.e. is free of any distortion d1 as shown in the left panel, the dot pattern 3 on the target 2 will show a distortion d2 due to the non-ideal behavior of the projection lens TX. The distorted pattern is illustrated in the right panel of the figure. Typically, the distortion introduced by a realistic lens is a highly non-linear effect as illustrated in the bottom panel for the lens of FIG. 3a. In particular, a distortion d2 of the dot pattern can lead to some dots being squashed closer to their neighbors close to the center of the array, while dots further away are stretched apart, for instance. This is commonly referred to as a complex type of distortion.

However, other types such as barrel or pincushion distortion are likewise possible.

Similar to FIGS. 3a and 3b, FIGS. 4a and 4b illustrate the introduction of distortion by means of a real non-ideal camera lens RX, as depicted in FIG. 4a. If a non-distorted dot pattern is given, as shown in the left panel, the dot pattern 3 on the array of sensor pixels 21 will show a distortion d3 due to the non-ideal behavior of the camera lens RX. The distorted pattern is again illustrated in the right panel of the figure. For this lens, a distortion d3 of the imaged dot pattern leads to the dots being stretched apart increasingly with their distance, for example, commonly referred to as a barrel type distortion, often observed for concave spherical lenses. Alternatively, pincushion distortion or other complex types can be realized, e.g. by employing a convex spherical lens. The distortion on the input side can lead to the fact that not all dots of the dot pattern 3 reach the corresponding sensor pixel in the center of the photosensitive surface, or even at all.

FIG. 5 shows a first exemplary embodiment of a distortion compensation mechanism for a TOF camera 1. In this embodiment, as shown in panel (a), the array of light emitters 11 features a radially symmetric barrel type distortion d1. This means that the array can still be defined by rows and columns, however, the lines bulge outwards at the center and are thus not parallel to each other. Therein, the type and degree of the distortion d1 is set such that the optical distortion introduced by the projection lens TX, e.g. the exemplary projection lens TX of FIGS. 3a and 3b, is compensated. In other words, the distortion d1 is of the same magnitude but opposite sign of that introduced by the projection lens TX. This leads to the dot pattern 3 being free of any distortion as illustrated in panel (b). In other words, the dot pattern 3 on the target 2 can be described by a rectangular array of dots arranged in rows and columns that are parallel to each other. Moreover, this embodiment assumes an ideal camera lens RX that does not introduce any optical distortion. Thus, the non-distorted dot pattern 3 is projected onto the array of sensor pixels 21 such that each dot hits the center of the corresponding respective sensor pixel 21, the correspondence again being defined by means of having the same row and column index (or being axis or point mirrored). This is illustrated by the circles representing the dots of the imaged dot pattern being concentric with the square-shaped sensor pixels 21.

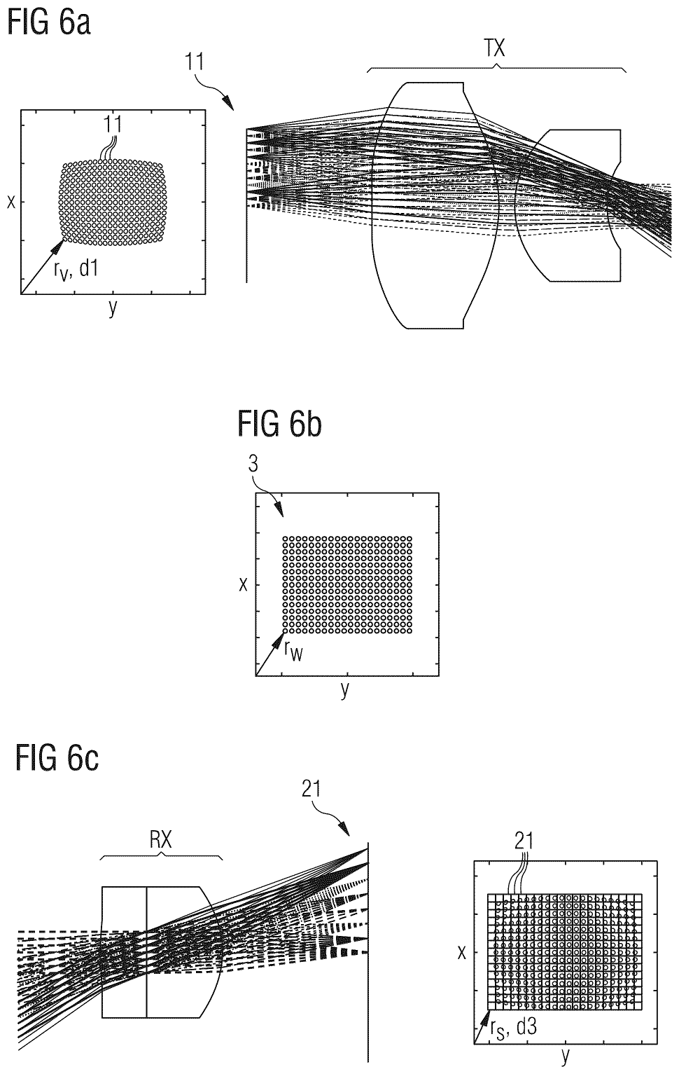

FIG. 6 shows the first exemplary embodiment of a distortion compensation mechanism for a TOF camera 1 of FIG. 5 in case a real lens is employed as the camera lens RX. In other words, with reference to panel (c), the camera lens RX introduces a distortion d3 that manifests itself in the dot pattern not being projected onto the sensor pixels 21 in a manner, in which each dots hits the center of a corresponding sensor pixel 21. This is an unwanted behavior and serves to illustrate the fact that both the distortion introduced by the projection lens TX and that of the camera lens RX need to be compensated for in order to achieve a desirable result in a real system.

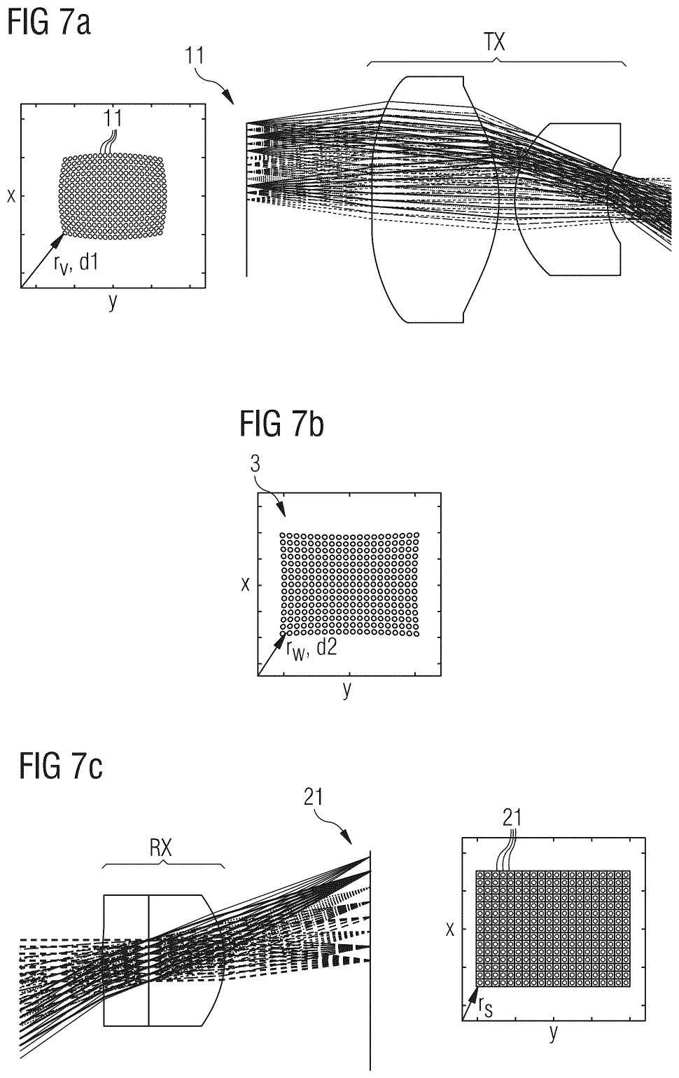

FIG. 7 shows a second exemplary embodiment of a distortion compensation mechanism for a TOF camera 1. Compared to the first embodiment of FIG. 5 and that of FIG. 6, in this embodiment the distortion d1 of the array of light emitters 11 is set such that not only the optical distortion due to the projection lens TX but also that of the camera lens RX is compensated. This firstly leads to the fact that the dot pattern 3, as illustrated in panel (b) compared to FIG. 5 now likewise experiences a distortion d2, in this case a pincushion type distortion, which is then compensated for by the optical distortion of the camera lens RX, such that again the desired result of each dot of the dot pattern hitting a corresponding one of the pixel sensors 21, as illustrated in panel (c). The types and degree of the distortion d1 of the array of light emitters 11 and of the predetermined distortion d2 of the dot pattern depend on the transfer functions L_{TX}, L_{RX} of the projection and camera lenses TX, RX and can be of a different degree and/or type for different lenses and lens types, such that the imaged dot pattern on the sensor pixels 21 is free of any distortion d3. The first and second embodiments can be employed for direct projection systems, where one emitter 11 produces one dot in the dot pattern 3. It can also be used to minimize distortion in projection lenses TX comprising of a lens element and a diffractive optical element, in which one emitter produces 1×N dots, with N being the total number of orders of the DOE.

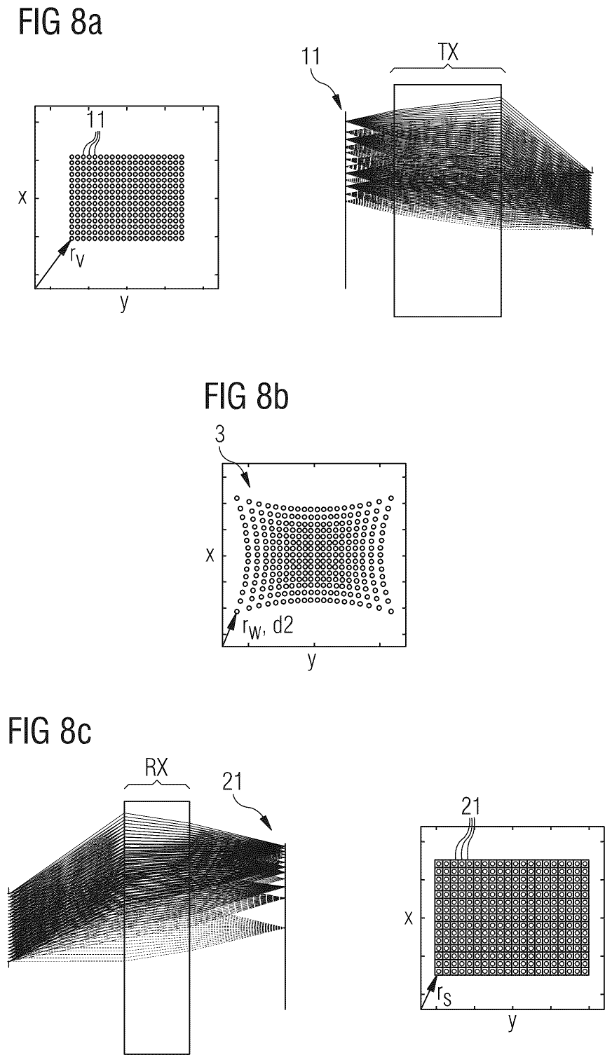

FIG. 8 shows a third exemplary embodiment of a distortion compensation mechanism for a TOF camera 1. Compared to the previously described embodiments, in this embodiment the array of light emitters 11 is free of any distortion d1, such that all light emitters 11 are arranged in a rectangular grid characterized by rows and columns that are parallel to each other. Thus, in order to achieve zero, or at least minimal, distortion d3 of the imaged dot pattern on the sensor pixels 21, the transfer functions L_{TX}, L_{RX} of the projection and camera lenses TX, RX are engineered to compensate each other in terms of optical distortion introduced. For example, the projection lens TX generates a dot pattern 3 on the target that is characterized by a pincushion type of distortion d2, as illustrated in panel (b), which is then picked up by the camera lens RX that reverses this distortion d2. In other words, the projection and camera lenses TX, RX introduce an equal degree of distortion but of opposite signs. This type of distortion compensation can be implemented with direct projection and meta-optics lenses, which due to their architecture are prone to high levels of distortion. In particular this embodiment allows for completely correcting for distortion of a distorted dot projector, a projection lens TX which comprises a DOE, or an MLA dot projector, or in general any dot projector with distortion.

As it is typically not desirable to distort the array of sensor pixels 21, the three degrees of freedom for the distortion compensation include the distortion d1 of the array of light emitters 11, the distortion of the projection lens TX due to its transfer function L_{TX}, and the distortion of the camera lens RX due to its transfer function L_{RX}. Thus, the abovementioned embodiments can also be combined to enhance the distortion correction method by adjusting all, the distortion of the array of light emitters 11, and the transfer functions of both lenses TX, RX.

FIG. 9 shows an exemplary embodiment of an electronic device 100, e.g. a smartphone or a smart watch, comprising a TOF camera system 101 with a TOF camera 1 according to the improved concept. The camera system 101 comprises a TOF camera 1 and a control and processing unit 102 electrically coupled to the TOF camera 1. The control and processing unit 102 is configured to operate the TOF camera 1, i.e. control emission of the dot projector 10 and the detection of the dot pattern 3 on the target 2 via the optical sensor 20, and to receive photo signals from each of the sensor pixels 21 for determining a distance to and/or topographic characteristics of the target 2 via a time difference between emission and detection of optical pulses.

The embodiments of the TOF camera 1 and the distortion compensation method disclosed herein have been discussed for the purpose of familiarizing the reader with novel aspects of the idea. Although preferred embodiments have been shown and described, changes, modifications, equivalents and substitutions of the disclosed concepts may be made by one having skill in the art without unnecessarily departing from the scope of the claims.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

This patent application claims the priority of German patent application DE 10 2022 116 581.7, the disclosure content of which is hereby incorporated by reference.

### REFERENCES

1 TOF camera
2 target
3 dot pattern
10 dot projector
11 light emitter
20 optical sensor
21 sensor pixel
30 substrate
100 electronic device
101 TOF camera system
102 control and processing unit
RX camera lens
TX projection lens
L_{TX}, L_{RX} transfer function
d1, d2, d3 distortion
r_{V}, r_{W}, r_{S} position vector

1. A time-of-flight, TOF, camera, comprising:
a dot projector formed from an array of light emitters and a projection lens, the dot projector being configured to project a dot pattern onto a target; and
an optical sensor formed from an array of sensor pixels and a camera lens, the optical sensor being configured to capture the dot pattern projected onto the target;
wherein a distortion of the array of light emitters, a transfer function of the projection lens and/or a transfer function of the camera lens is set such that the captured dot pattern is free of optical distortion, wherein
the distortion of the array of light emitters is a complex type distortion and is set such that the dot pattern is free of any distortion, or such that a predetermined distortion of the dot pattern on the target is achieved.

2. The TOF camera according to claim 1, wherein each of the sensor pixels is adapted to detect a dot of the dot pattern that is generated by one of the light emitters located at a coordinate in the array of light emitters corresponding to a coordinate in the array of sensor pixels of the respective one of the sensor pixels.

3. The TOF camera according to claim 1, wherein a number of light emitters corresponds to a number of sensor pixels.

4. The TOF camera according to claim 1, wherein the transfer function of the camera lens is set such that light of each dot of the dot pattern is directed to a center of a capturing surface of a corresponding one of the sensor pixels.

5. The TOF camera according to claim 1, wherein the transfer function of the camera lens is set such that a distortion of the dot pattern caused by the distortion of the array of light emitters and/or the transfer function of the projection lens is reversed.

6. The TOF camera according to claim 1, wherein the transfer function of the projection lens is set such that the dot pattern is free of any distortion.

7. The TOF camera according to claim 1, wherein the transfer function of the projection lens is set such that a predetermined distortion of the dot pattern on the target is achieved.

8. The TOF camera according to claim 1, wherein the transfer function of the camera lens is set such that the predetermined distortion of the dot pattern on the target is reversed.

9. The TOF camera according to claim 1, wherein the light emitters are coherent light emitters, in particular vertical-cavity surface-emitting lasers, VCSELs.

10. The TOF camera according to claim 1, wherein each of the sensor pixels comprises a photodiode, in particular a micro photodiode.

11. The TOF camera according to claim 1, wherein the projection lens is formed from one of: injection-molded optics, wafer-level optics, a metalens, a micro-lens array.

12. The TOF camera according to claim 1, wherein the camera lens is formed from one of: injection-molded optics, wafer-level optics, a metalens, a micro-lens array.

13. The TOF camera according to claim 1, wherein the dot projector comprises a single light emitter and further comprises a diffractive optical element configured to generate a dot array from light received from the single light emitter.

14. An electronic device comprising a TOF camera according to claim 1.

15. A distortion compensation method for a time-of-flight camera, the method comprising:
providing a dot projector formed from an array of light emitters and a projection lens;
providing an optical sensor formed from an array of sensor pixels and a camera lens;
projecting, by means of the dot projector, a dot pattern onto a target; and
capturing, by means of the optical sensor, the dot pattern projected onto the target;
wherein a distortion of the array of light emitters, a transfer function of the projection lens and/or a transfer function of the camera lens is set such that the captured dot pattern is free of optical distortion, wherein
the distortion of the array of light emitters is a complex type distortion and is set such that the dot pattern is free of any distortion, or such that a predetermined distortion of the dot pattern on the target is achieved.
